(19) United States
(12) Patent Application Publication
(10) Pub. No.: US 2005/0256984 A1
(43) Pub. Date: Nov. 17, 2005

(54) Implementation of a master loopback mode

(76) Inventors: Peter Joel Jenkins, Colchester, VT (US); Paul Joseph Mattos, Jericho, VT (US); Stanley B. Stanski, Essex Junction, VT (US)

Correspondence Address: McGuireWoods LLP, Suite 1800, 1750 Tysons Boulevard, McLean, VA, 22102, US

(21) Appl. No.: 10/844,530

(22) Filed: May 13, 2004

(51) Int. Cl. G06F 13/00

(52) U.S. Cl. 710/100

(57) ABSTRACT

The invention is directed to determining the link integrity using information in a industry standard connection protocol, such as the Peripheral Component Interconnect Express® industry standard system level bus interconnect protocol. One or more features required in the industry standard protocol are used to implement a loopback master and a loopback slave in an interface device (also referred to as an interface) and an external component or device. Using such features may consume less logic area and provide a robust environment for checking link integrity and capabilities.

### FIELD OF THE INVENTION

The invention relates to determining the link integrity between an interface and a component, and more specifically to determining the link integrity using information in a Peripheral Component Interconnect Express® industry standard system level bus interconnect protocol.

### BACKGROUND OF THE INVENTION

An interface is typically needed where computer devices must transfer transactions and commands between one another, so that the transactions or commands of one device can be received and properly interrupted by the other device. Because the function of such an interface is to allow two different devices to communicate with one another, the interface will frequently be designed to an industry standard specification.

The industry standard specification specifies the type and format of the allowable inputs and outputs to and from the interface. Accordingly, any device or component which will interact through the interface must comply with the interface's specifications or protocols. This may allow devices and components designed and manufactured by different companies to interact with each other. An example of such an interface includes a Peripheral Component Interconnect (“PCI”).

PCI® is such an industry standard system level bus interconnect protocol. A PCI® bus allows peripheral devices and components, like memory, video cards, printers, etc. to be functionally added to a computer system. The PCI® bus also allows a peripheral using a proprietary system to communicate with the controlling computer using predefined industry standard commands or transactions. Examples of such transactions include memory read and write, interrupts, errors and other messages. Additionally, a PCI® bus may send and receive both input/output (“I/O”) and memory instructions.

An example of such an industry standard specification for the PCI® interface is PCI Express®. A PCI Express® interface provides a system level bus interconnect applied to a computer system with a processor having a processor specific local bus. The PCI Express® interface may be used where most of any memory and system accesses occur and would also include a PCI® host bridge that would allow the system to bridge from the proprietary system of the system bus to the industry standard PCI® bus. The PCI® bus would then allow the addition and interface of devices like memory, video cards, printers, etc., which would then interact with the processor specific local bus though the PCI® bus.

In addition to facilitating communication between a device or a peripheral component and a computer system, an interface also may have the capability to allow a computer system to automatically detect and configure a device. Such detection and configuration is commonly referred to as “plug and play” and requires that the interface and the device be capable of sending and receiving commands to configure the computer and the device for operation. Such communication commands may include, for example, memory range, I/O range, and number of interrupts. Such configuration commands are transmitted through configuration space. Accordingly, both the interface and the peripheral attached thereto are configured to send and receive commands through configuration space at start-up in order for the computer system to configure the device for use.

A configuration bus is a component of the interface to facilitate the transmission and reception of configuration commands in order to allow software to set-up a system to function with a peripheral and to adjust to hardware changes. Typically, a configuration space has a combination of read only registers which are configured to describe the device. The read only registers are located on the device and include information such as, for example, the type of the device, the class of the device, the manufacturer of the device and registers which define the system resources the device needs to operate. Additionally, the device may have registers that enable the device to generate messages such as an interrupt. Also, the appropriate software drivers may be determined by information in the registers. Thus, configuration space may have a set of predefined read only registers which generally describe the device, describe the required system resources, and registers containing information which enable the bus to begin communication with the device. Also, an interface may utilize configuration commands which are unique to the interface.

Implementation of a loopback capability in serial link specifications and applications is a generally accepted practice used to aid system and link evaluation and diagnostics. Entry into and exit from loopback mode is generally specified in industry standards, such as PCI Express®, but the behavior of the system when in loopback mode, such as, for example, the information to be transmitted by the loopback initiator, is not normally specified. The standard practice is to define a set of information or a pattern to be transmitted based on specific system characteristics to be tested, and then develop unique logic to create and transmit that information or pattern.

When implementing a widely used protocol such as PCI Express®, however, a wide variety of systems may be designed using one generic component. It is therefore difficult to define a set of information or a pattern that will offer useful diagnostic capability for that wide variety of systems when those systems are in loopback mode. To resolve the problem, many sets of information or patterns may be implemented so that specific systems can choose between them. This, however, increases the cost of implementing loopback in the one generic component.

FIG. 1 illustrates a schematic representation of an interface and component in a loopback relation according to a know configuration. Interface 100 and component 180 are shown in connection to each other. The interface and component use the PCI Express® industry standard protocol. Interface 100 is set as a loopback master, while component 180 is set as a loopback slave.

The interface 100 includes logic for performing various functions, including logic used in PCI Express®. This logic includes Ordered Set Generator 110, Packet Generator 120, Loopback Control 130, Loopback Pattern Generator 140 and Loopback Pattern Checker 150, which are all well understood in the art. Interface further includes a transmission connection 160 and a receiver connection 170 to and from component 180.

The Ordered Set Generator 110 and Packet Generator 120 are used to perform functions associated with the PCI Express® protocol. More specifically, Ordered Set Generator 1110 may generate ordered sets and compliance pattern, while packet generator 120 generates information packets. The Loopback Control 130, Loopback Pattern Generator 140 and Loopback Pattern Checker 150 are additional logic added to determine link integrity.

The Loopback Pattern Generator 140 is used to create a data set which is transmitted to the component 180. Ordered Set Generator 110 may generate an ordered set, while Packet Generator 120 may generate a compliance pattern packet. While the industry standard PCI Express® specification defines the method for negotiating entry into the loopback mode, it does not define the behavior of the loopback master once in loopback mode. So, Loopback Pattern Generator 140 must be created to generate one or more patterns which, based on Loopback Control 130, are sent from interface 100 to component 180, and then back to Loopback pattern checker 150 to determine link integrity. Use of this additional logic may increase the space requirements for overall control of the interface and device or component interaction when determining link integrity. Further, complexity in the interaction between the interface and component during a determination of link integrity is increased.

### SUMMARY OF THE INVENTION

An exemplary aspect of the invention provides a method for determining link integrity for a component connection having a known standard connection protocol. The method includes providing a first data set having a first use and converting the first data set to a second use. The method further includes transmitting the first data with the second use through a feed back loop and comparing the first data set with the second use to a received data set to verify the second use.

A further exemplary aspect of the invention provides a method for determining link integrity for a component connection. The method includes transmitting a first data set to a component from an interface, where the first data set is associated with and used in an interface connection protocol. The method further includes receiving a received data set from the component and comparing the first data set and the received data set to determine if the first data set and the received data set are the same.

An addition exemplary aspect of the invention provides a computer program product comprising a computer usable medium having a readable program code embodied in the medium. The computer program product includes at least one program code to provide a first data set having a first use and convert the first data set to a second use. The computer program product further includes at least one program code to transmit the first data with the second use through a feed back loop and compare the first data set with the second use to a received data set to verify the second use.

### BRIEF DESCRIPTION OF THE DRAWINGS

The above and other features and advantages of the invention will become more apparent to those of ordinary skill in the art by describing in detail exemplary embodiments thereof with reference to the attached drawings.

FIG. 1 is a schematic representation of an interface and component in a loopback relation according to a known configuration;

FIG. 2 is a schematic representation of an interface and component in a loopback relation according to an embodiment of the invention; and

FIG. 3 is a flowchart illustrating the steps for determining link integrity according to an embodiment of the invention.

### DETAILED DESCRIPTION OF EMBODIMENTS OF THE INVENTION

The invention uses features of industry standard connection protocols to assist in determining link integrity between an interface and a component or device. By way of one exemplary embodiment, one or more features of the PCI Express® standards are used as data sets to implement a loopback master and a loopback slave in an interface device (also referred to as an interface) and an external component or device. Using such features may consume less logic area and provide a robust environment for checking link integrity and capabilities.

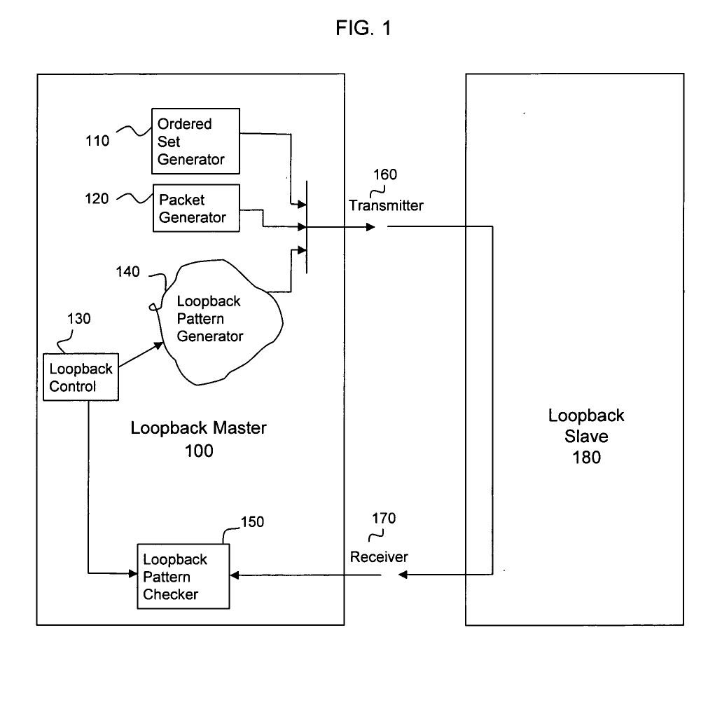

According to an embodiment of the invention, logic found in the industry standard protocol is converted from its initial or first use, to a second use of determining link integrity. Thus, less additional, and overall, logic may be used to determine link integrity and reduce complexity for an interface and component connection using PCI Express®. For example, an interface and component using the PCI Express® standard protocol may implement a master loopback capability which may be used to enable additional test and diagnostic features for a system. As described above with respect to FIG. 1, the industry standard PCI Express® specification defines the method for negotiating entry into the loopback mode, but does not define the behavior of the loopback master once in loopback mode. Therefore, each implementation of a loopback master may define the data to transmit and also the loopback master behavior if and/or when the data set is received back from the loopback slave. An embodiment of the invention provides specific implementations of the loopback master and defining the data set to transmit by using logic already required by the industry standard to provide the data set, rather than provided additional logic that takes up space and increases complexity.

The loopback mode is a setting defined in the PCI Express® standards that cause the interface to transmit one or more selected data sets to the component. The interface then receives from the component one or more received data sets, where the second data set is supposed to match the selected data set. Based on the actual match, the link integrity may be evaluated. The PCI Express® standard further defines a “compliance pattern” and several “ordered sets” of information which are transmitted during specific link states of the interface and the component, as well as data packets. A compliance pattern is used to test the capabilities of the link. For example, the compliance pattern may interact with connected test equipment to determine if required electrical characteristics of the link have been met, such as the data rate and voltage swings. Ordered sets are used to negotiate the size and capabilities of a link. Further, ordered sets are used to direct the link mode, such as, for example, disabling a link, resetting a link, turning a link on or off, or the like. Once a link is negotiated, packets are generated to communicate data, as well as perform link maintenance, such as confirming that a data packet was received.

The compliance pattern, the ordered sets and the data packets implemented by the invention may be used while the interface and component are placed in a loopback mode for determining link integrity and capability testing and reporting. By using known and defined data sets, as now used in the invention, such as the compliance pattern and/or the ordered sets, a comparison between what was sent and what was received may be more easily made with less addition logic or information in the program code (e.g., software, hardware, etc.).

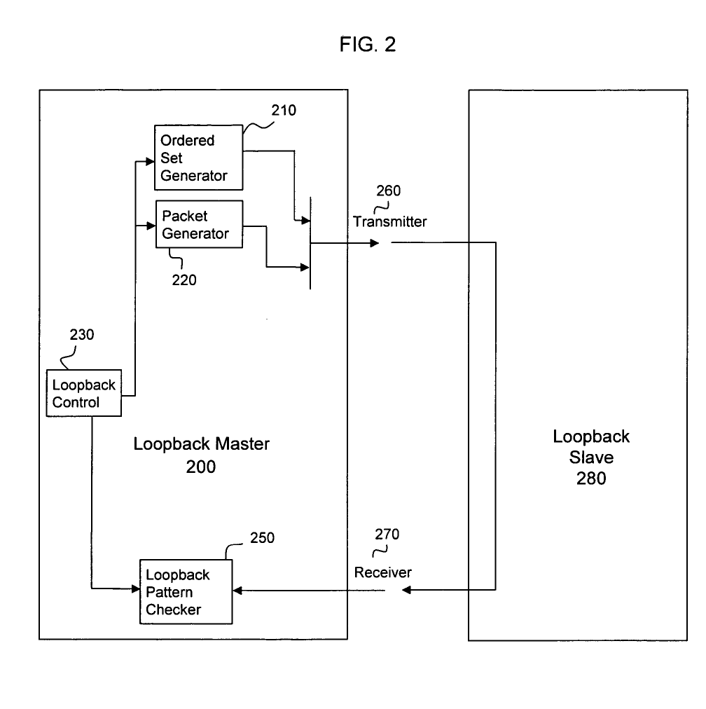

FIG. 2 illustrates a schematic representation of an interface and component in a loopback relation according to an embodiment of the invention. Interface 200 and component 280 are shown in connection to each other. For purposes of this exemplary embodiment of the invention, the interface and component use the PCI Express® version 1.0a industry standard protocol. However, it is understood that any industry standard protocol for connecting an interface and a component may be used. Interface 200 is set as a loopback master, while component 280 is set as a loopback slave.

The interface 200 includes logic for performing various functions, including logic used in PCI Express®. This logic includes Ordered Set Generator 210, Packet Generator 220, Loopback Control 230, and Loopback Pattern Checker 250, and are well known in the art. Interface further includes a transmission connection 260 and a receiver connection 270 to and from component 280.

In an exemplary embodiment of the invention, the Ordered Set Generator 210, and Packet Generator 220 are used to perform functions associated with the PCI Express® protocol as required in the PCI Express® industry standard protocol. The Loopback Control 230 and Loopback Pattern Checker 250 are additional logic added to implement the invention. Thus, according to exemplary embodiment of the present invention, portions of the additional logic, such as that illustrated in FIG. 1, may be eliminated and replaced by logic that is required for other functions. That is, the Loopback Pattern Generator 140 may be eliminated and replaced by Ordered Set generator 210 and Packet Generator 220.

One of the Ordered Set Generator 210 and the Packet Generator 220 are used to create a data set to transmit to the component 280. Ordered Set Generator 210 may generate an ordered set and/or a compliance pattern, while Packet Generator 220 may generate a data packet.

According to an embodiment of the invention, transmitting the compliance pattern and/or the ordered set during master loopback mode requires less logic, since the patterns are required to be transmitted in other link states per the PCI Express® specification. Thus, using these already required data sets may produce a lower-cost solution.

One implementation is defined to use the compliance pattern. The pattern is designed to create significant interference between adjacent lanes of a multi-lane link. Thus, using such an embodiment during master loopback mode provides an effective way of stressing the link's integrity throughout the system.

Another exemplary embodiment of the invention uses ordered sets, such as the TS1 and TS2 training ordered sets. As required by the PCI Express®, the training ordered sets may negotiate and control the link between an interface and a device or component. These ordered sets may contain information such as the link number, and that information can be used to infer the link's topology. In a connection between an interface and a device or component, wire connectors, or the like, in the interface and the component, referred to as lanes, contact each other. These connectors, not shown, are well known in the computer and peripheral device art. For example, if the training ordered sets are transmitted with lane numbers assigned 0 for lane 0 and 1 for lane 1 on a 2-lane link, and are received 1 on lane 0 and 0 on lane 1, it can be deduced that the lanes have been cross-connected in the system. This can obviously be extended to links which contain more lanes.

The master loopback's pattern checker 250 may, in either case, look for errors in the received data (encoding, symbol lock, clock compensation, etc.) and can be used to diagnose link integrity and link training. Loopback may be implemented to enable a check on the quality of the link between the interface 200 and the component 280. Determining link integrity may be desirable for implementing a component connection, such as to implement a personal computer motherboard type of connection. Thus, the loopback mode may be used as a diagnostic mode in the operating system. When used for a diagnostic mode, the loopback mode checking or comparing data transferred between the interface 200 and component 280. The data transferred between the interface 200 and component 280 includes data generated from logic required to be implemented based on the base specification of the PCI Express® protocol. Checking or comparing may involve looking for errors in the data. For example, logic in the interface 200 generates a data set and transmits it to the component 280. A second data set is received by the interface 200 from the component 280. The generated data set and the second data set are compared to determine if there are any errors.

According to an exemplary embodiment of the invention, the base specification for PCI Express® defines the concept of loopback. With reference to FIG. 2, the loopback concept allows a particular component 280 to be set as a loopback slave bus and the interface 200, including the computer connected to the interface, to be set as a loopback master. The base specification for PCI Express® further defines how the loopback master, that is, the interface 200, initiates loopback to the loopback slave, that is, the component 280. However, the loopback mode does not define what is actually transmitted from the interface 200 to the component 280.

According to an exemplary embodiment of the invention, the PCI Express® standard protocol requires the implementation of a compliance pattern. A compliance pattern is designed to provide interference with the link between the interface 200 and the component 280. The compliance pattern is a pattern that is sent on all the lines. Thus, the compliance pattern enables a determination that what the interface 200 transmitted to the component 280 was actually received from the component 280 by the interface 200 in the loopback. The results may be compared to the transmission to look for errors, for example. However, using the compliance pattern, due to the pattern state of the data, may not allow a determination of the link integrity of a particular lane.

According to another exemplary embodiment of the invention, the PCI Express® standard protocol shall require the implementation and transmission of ordered sets. Order sets may provide different usability features than that in the compliance pattern. In particular, order sets may identify the lane number for transmitting and receiving. By way of example, an ordered set logic generates an ordered set with unique lane numbers. The received data, corresponding to the ordered set, is observed with respect to the unique lane numbers. Thus, using ordered sets in a loopback mode may allow a diagnosis of the lines of a board connected in a non-useable way. The ordered sets may be a specific diagnostic as compared to the compliance pattern.

By way of an exemplary embodiment of the invention, a compliance pattern is provided with the loopback mode. If the interface 200 receives the same compliance pattern that it sent out, the link integrity between the interface 200 and the component 280 may be confirmed. If problems occur in receiving the compliance pattern transmitted, then various ordered sets may be used to more precisely determine the problem with the link between the interface 200 and the component 280, that is, what line is not connected, has static interference, etc.

In an exemplary embodiment of the invention, the PCI Express® standards shall explicitly define the compliance pattern. Further, the framework for the ordered sets is also explicitly defined. Five fields within the ordered sets may be used to negotiate and control the link between the interface 200 and the component 280. These fields may include training control (described above), the link number, the line number, the number of training sets and the data rate. Thus, the capabilities of the interface and the device or component may be advertised. These fields are well known in connection with PCI Express®.

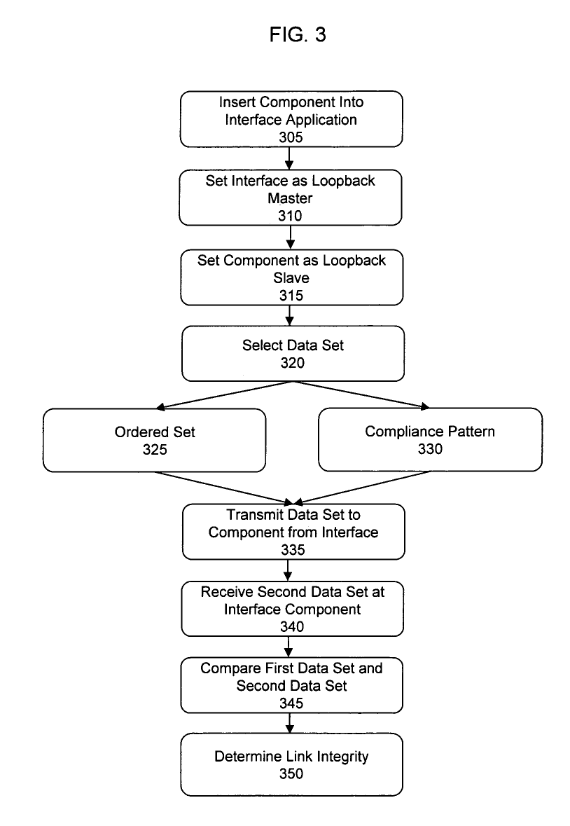

FIG. 3 flow diagram illustrating the steps for determining link integrity according to an embodiment of the invention beginning at 305. FIG. 3 may equally represent a high-level block diagram of components of the invention implementing the steps thereof. The steps of FIG. 3 may be implemented on a computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network. FIG. 3 may also be implemented, for example, using the components represented by FIG. 2.

At 305, a component is inserted into an interface. As described above, the component may be any device, such as a printer, scanner, memory card, game card, or the like. Further, the interface may connect to a processor, such as in a personal computer. When inserting the component into the interface, it is understood that a known standard connection protocol is used to facilitate the connection. Examples of known standard connection protocol include, but are not limited to, PCI® and PCI Express®.

The interface is set as a loopback master at 310, and the component is set as a lookback slave at 315. At 320, the data set is selected. The data set may be an ordered set 325 or a compliance pattern 330. According to an exemplary embodiment described above, where the known standard connection protocol is PCI Express®, the compliance pattern may be used to test the link integrity of the entire connection, while ordered sets may be used to test the link integrity of selected lanes.

The selected data set is transmitted at 335. The interface, as the loopback master, transmits the data set to the component, the loopback slave. A second data set is received at 340. The second data set is received from the component (e.g., the loopback slave) at the interface (e.g., the loopback master).

At 345, the selected data set and the second data set are compared. Based on the comparison, the link integrity is determined at 350. That is, because the content of the selected data set is know, the second data may be compared to the selected data set to determine whether the interface and the component are properly connected.

According to an exemplary embodiment of the invention, the costs of implementing loopback may be minimized by re-using specific features required in the industry standard connection protocol, such as PCI® Express implementations in a unique manner.

According to an embodiment, the invention may be used with computer processing units (CPUs), chipsets, and add-in cards with PCI Express® capability. Other industry standard protocols include various versions of Conventional PCI™, PCI-X®, and PCI Express®, developed by PCI-SIG, a group that owns and manages PCI® specifications as open industry standards. Other protocols currently known or yet to be developed may also be used as applicable.

In an exemplary embodiment of the invention, using a PCI Express® industry standard protocol, the method of initiating the master loopback mode of the product is well know to users. Once the mode is initiated, the pattern can be observed with industry standard test equipment. Thus, observing and comparing the sent compliance pattern, ordered set, and/or packet data with the received compliance pattern, ordered set and/or packet data allows a determination of the link integrity and whether the link is accessible.

While the invention has been described in terms of exemplary embodiments, those skilled in the art will recognize that the invention can be practiced with modifications and in the spirit and scope of the appended claims.

1. A method for determining link integrity for a component connection having a known standard connection protocol, comprising the steps of:
providing a first data set having a first use;
converting the first data set to a second use;
transmitting the first data set with the second use through a feed back loop; and
comparing the first data set with the second use to a received data set to verify the second use.

2. The method of claim 1, wherein the second use is determining link integrity.

3. The method of claim 1, wherein comparing the first data set with the second use to a received data set occurs at the completion of the transmitting of the first data set.

4. The method of claim 1, wherein the first data set is a known standard connection protocol.

5. The method of claim 1, wherein:
the first data set with the second use is transmitted from a loopback master; and
the received data set is received from a loopback slave.

6. The method of claim 5, wherein:
the loopback master and the loopback slave are connected by at least one lane; and
the received data set with the second use includes at least one lane assignment.

7. The method of claim 6, wherein comparing the first data set and the received data set includes determining the link integrity of the at least one lane from the at least one lane assignment.

8. A method for determining link integrity for a component connection, comprising the steps of:
transmitting a first data set to a component from an interface, where the first data set is associated with and used in an interface connection protocol;
receiving a received data set from the component; and
comparing the first data set and the received data set to determine if the first data set and the received data set are the same.

9. The method of claim 8, further comprising the step of determining link integrity based on the comparison of the first data set and the received data set.

10. The method of claim 8, wherein the protocol is a peripheral component interconnect express protocol for the interface and the component.

11. The method of claim 8, further comprising:
setting the interface as a loopback master; and
setting the component as a loopback slave.

12. The method of claim 8, wherein:
the component and the interface are connected by at least one lane; and
the first data set includes at least one lane assignment.

13. The method of claim 13, wherein the at least one lane assignment indicates the at least one lane for either the transmission of the first data set or the receipt of the received data set.

14. The method of claim 13, wherein comparing the first data set and the received data set includes determining the link integrity of the at least one lane from the at least one lane assignment.

15. The method of claim 8, wherein the first data set comprises a compliance pattern, and the compliance pattern is compared to the received data set to determine link integrity.

16. The method of claim 8, where in the first data set comprises an ordered set and the ordered set is compared to the received data set to determine link integrity.

17. A computer program product comprising a computer usable medium having a readable program code embodied in the medium, the computer program product including at least one program code to:
provide a first data set having a first use;
convert the first data set to a second use;
transmit the first data with the second use through a feed back loop; and
compare the first data set with the second use to a received data set to verify the second use.

18. The computer program product of claim 17, wherein the computer program product further includes at least one program code to determine link integrity based on the comparison of the first data set and the recieved data set.

19. The computer program product of claim 17, wherein the data set with the second use is includes at least one lane assignment.

20. The computer program of claim 19, wherein the at least one lane assignment indicates the at least one lane for either the transmission of the first data set or the receipt of the received data set.
